(19) United States
(12) Patent Application Publication
(10) Pub. No.: US 2009/0175596 A1
(43) Pub. Date: Jul. 9, 2009

(54) PLAYBACK APPARATUS AND METHOD

(75) Inventor: Jun HIRAI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/348,488

(22) Filed: Jan. 5, 2009

(30) Foreign Application Priority Data
Jan. 9, 2008 (JP) P2008-001787

(51) Int. Cl. H04N 7/00

(52) U.S. Cl. 386/97; 348/468; 386/E05.001; 348/E07.001

(57) ABSTRACT

A playback apparatus for playing back video information, audio information, and subtitle information from a recording medium, the recording medium having recorded thereon video information, audio information associated with the video information, and subtitle information corresponding to utterance information included in the audio information, the utterance information and the subtitle information being given in a plurality of languages, includes a mode switching unit that switches between a normal playback mode and a language-learning playback mode, and a control unit that, when the language-learning playback mode is set, plays back video information and audio information associated with the video information and reads, from the recording medium, subtitle information given in the same language as a language of utterance information included in the audio information to be played back to perform playback in which subtitles based on the subtitle information are superimposed and displayed on video based on the video information.

### CROSS REFERENCES TO RELATED APPLICATIONS

The present invention contains subject matter related to Japanese Patent Application JP 2008-001787 filed in the Japanese Patent Office on Jan. 9, 2008, the entire contents of which are incorporated herein by reference.

### BACKGROUND OF THE INVENTION

1. Field of the Invention

The present invention relates to an apparatus and method for playing back recording media such as digital versatile discs (DVDs) having recorded thereon content such as films and television dramas, and more specifically to an apparatus and method suitable for use in language learning.

2. Description of the Related Art

A great number of copies of special language learning (or conversation training) software are being proposed. However, there are not so many types of language learning (or conversation training) software available and people get tire of them. In addition, the proposed language learning software generally includes comparatively clear pronunciation rather than native, difficult-to-catch accent pronunciation. Furthermore, not so many slang words and informal phrases are included, which may be insufficient to allow learners to achieve levels comparable to native speakers in actual life.

Recently, disc-based recording media such as DVDs or Blu-ray Disc® (BD) discs and other recording media having foreign film content recorded thereon have been commercially available. Purchasing the recording media and repeatedly playing back and viewing the film content may be an effective way to learn foreign languages. However, it may be difficult for users who have not achieved sufficiently high levels to efficiently learn languages.

In order to overcome this difficulty, Japanese Unexamined Patent Application Publication No. 2001-22265 proposes a system in which, instead of modifying original film content, new re-edited language-learning auxiliary software based on the original film content is created so that a combination of the original film content and the language-learning auxiliary software can help a learner learn a language using a personal computer.

Japanese Unexamined Patent Application Publication (translation of PCT Application) No. 2003-527000 describes a system for language learning using an apparatus adapted to record and play back closed-caption data of a digital television broadcast program and conversational speech corresponding thereto.

### SUMMARY OF THE INVENTION

In the system disclosed in Japanese Unexamined Patent Application Publication No. 2001-22265, in order to create new re-edited language-learning auxiliary software based on original film content, a special apparatus is necessary in addition to an apparatus for playing back the original film content. A personal computer is also necessary.

In addition, in the system disclosed in Japanese Unexamined Patent Application Publication (translation of PCT Application) No. 2003-527000, an apparatus for recording and playing back closed-caption data and conversational speech portions corresponding thereto is necessary, which may causes users to perform time-consuming processing. This may also cause user extra expense involved in purchasing the apparatus.

It is therefore desirable to provide an apparatus and method for playing back a recording medium such as a DVD storing video content for use in language learning in which a user can efficiently learn a language by performing a simple operation.

An embodiment of the present invention provides a playback apparatus for playing back video information, audio information, and subtitle information from a recording medium, the recording medium having recorded thereon video information, audio information associated with the video information, and subtitle information corresponding to utterance information included in the audio information, the utterance information and the subtitle information being given in a plurality of languages, the playback apparatus including mode switching means for switching between a normal playback mode and a language-learning playback mode, and control means for, when the language-learning playback mode is set by the mode switching means, playing back video information and audio information associated with the video information and reading, from the recording medium, subtitle information given in the same language as a language of utterance information included in the audio information to be played back to perform playback in which subtitles based on the subtitle information are superimposed and displayed on video based on the video information.

In the embodiment of the present invention, the playback apparatus has a normal playback mode and a language-learning playback mode. When the playback apparatus is switched to the language-learning playback mode, the control means is configured to read, from the recording medium, subtitle information in the same language as a language of utterance information included in audio information to be automatically played back and to perform playback in which subtitles based on the subtitle information are superimposed and displayed on video based on the video information.

Therefore, by performing a simple operation of switching the playback apparatus to the language-learning playback mode, a user can view subtitle information in the same language as a language of utterance information included in audio information to be played back to check utterances and can efficiently learn a language.

In the playback apparatus, the recording medium may have recorded thereon information regarding a start point and an end point of a superimposition time period for which a subtitle based on the subtitle information is superimposed on the video based on the video information. The playback apparatus may further include segmented-section detecting means for reading the start point and the end point of the superimposition time period from the recording medium and detecting the read start point and end point as a start point and an end point of a language-learning segmented section. In the language-learning playback mode, the control means may perform control to repeatedly play back at least audio information in the segmented section detected by the segmented-section detecting means, the segmented section being a section in which the subtitle information is superimposed on the video based on the video information.

Accordingly, the segmented-section detecting means may be configured to detect, as a start point and an end point of a language-learning segmented section, a start point and an end point of a time period for which a subtitle based on the subtitle information is superimposed on played back video. In the language-learning playback mode, the control means may perform control to repeatedly play back the segmented section in the language-learning segmented section which is detected by the segmented section detecting means, the segmented section being a section in which the subtitle information is superimposed on the video based on the video information.

The segmented section in which the subtitle information is superimposed and displayed on the video corresponds to an utterance section in the utterance information in the audio information. Therefore, repeated playback of the segmented section allows a user to efficiently learn a language.

According to an embodiment of the present invention, an apparatus for playing back a recording medium having video content recorded thereon in which efficient language learning is achieved with a simple operation can be realized.

### BRIEF DESCRIPTION OF THE DRAWINGS

FIG. 1 is a block diagram showing an example hardware configuration of a playback apparatus according to an embodiment of the present invention;

FIG. 2 is a diagram showing chapters used for language learning in the playback apparatus according to the embodiment of the present invention;

FIG. 3 is a diagram showing an example of a language-learning GUI in the playback apparatus according to the embodiment of the present invention;

FIG. 4 is a part of a flowchart showing an audio and subtitle setting process in the playback apparatus according to the embodiment of the present invention;

FIG. 5 is a part of the flowchart showing the audio and subtitle setting process in the playback apparatus according to the embodiment of the present invention;

FIG. 6 is a part of a flowchart showing a playback process in a language-learning playback mode of the playback apparatus according to the embodiment of the present invention;

FIG. 7 is a part of the flowchart showing the playback process in the language-learning playback mode of the playback apparatus according to the embodiment of the present invention;

FIG. 8 is a part of a flowchart showing a user input operation in the language-learning playback mode of the playback apparatus according to the embodiment of the present invention;

FIG. 9 is a part of the flowchart showing the user input operation in the language-learning playback mode of the playback apparatus according to the embodiment of the present invention;

FIG. 10 is a part of the flowchart showing the user input operation in the language-learning playback mode of the playback apparatus according to the embodiment of the present invention;

FIG. 11 is a part of the flowchart showing the user input operation in the language-learning playback mode of the playback apparatus according to the embodiment of the present invention;

FIG. 12 is a part of the flowchart showing the user input operation in the language-learning playback mode of the playback apparatus according to the embodiment of the present invention; and

FIG. 13 is a part of the flowchart showing the user input operation in the language-learning playback mode of the playback apparatus according to the embodiment of the present invention.

### DESCRIPTION OF THE PREFERRED EMBODIMENTS

A playback apparatus according to an embodiment of the present invention will be described hereinafter with reference to the drawings.

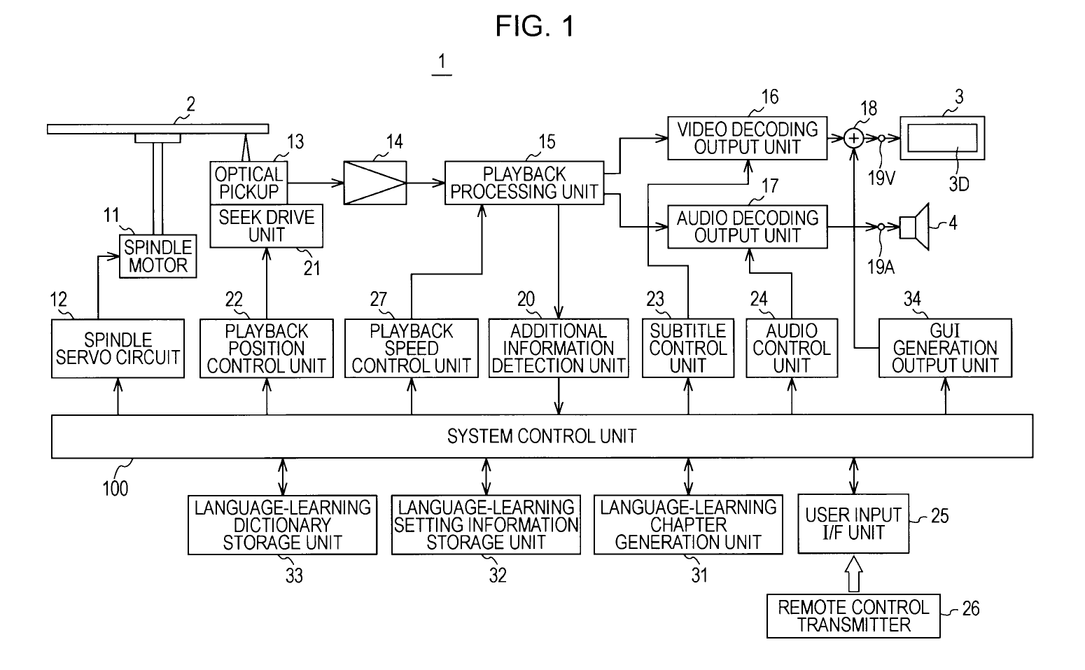

FIG. 1 shows an example hardware configuration of a playback apparatus 1 according to an embodiment of the present invention. In this example, a DVD 2 is used as a recording medium. In the embodiment, the DVD 2 is configured to record subtitle information which can include closed-caption information (hereinafter referred to as “subtitle information”) in a plurality of languages as additional information. The DVD 2 can be used for language learning, and preferably includes subtitle information in an original language of utterance information and subtitle information in a native language of a country where the DVD 2 is to be sold (that is, a native language of a user of the playback apparatus 1). The subtitle information may include time position information indicating a start point and an end point of a time period for which a subtitle is to be superimposed and displayed on played back video.

The term “utterance information” as used herein refers to audio information based on performers' speech or utterances in video content. The term “original language” as used herein refers to a primary language spoken by performers in the video content when the video content is created and refers to a language that dubbed languages are based on.

The DVD 2 is further configured to record audio information in the original language of the utterance information and dubbed audio information in a language of a country where the DVD 2 is to be sold (that is, a native language of a user of the playback apparatus 1).

Referring to FIG. 1, the DVD 2 is supported on a disc mounting unit (not shown) and is caused by a spindle motor 11 to rotate at a predetermined rotation speed. A speed servo signal is supplied to the spindle motor 11 from a spindle servo circuit 12 under control of a system control unit 100 to control the rotation speed of the spindle motor 11 accordingly.

The system control unit 100 includes a microcomputer. The system control unit 100 controls the overall operation of the playback apparatus 1, and stores a software program used therefor in an internal memory thereof.

In this embodiment, the playback apparatus 1 has a normal playback mode and a language-learning playback mode. A program for enabling the language-learning playback mode, which will be described below, as well as a normal playback mode program for implementing functions of an existing DVD playback apparatus, is stored in the internal memory of the system control unit 100.

An optical pickup 13 reads data recorded on the DVD 2, and supplies the read data to a playback processing unit 15 through a radio-frequency (RF) amplifier 14. The playback processing unit 15 includes a buffer memory (not shown) for temporarily storing the read data, and divides information read from the DVD 2 into video data, audio data, and additional information. The playback processing unit 15 supplies the obtained video data and audio data to a video decoding output unit 16 and an audio decoding output unit 17, respectively. The playback processing unit 15 further supplies the obtained additional information to an additional information detection unit 20.

The video decoding output unit 16 decodes the video data to generate a video signal adapted to display on a display 3, and outputs the generated video signal to a video signal output terminal 19V through a combining unit 18. The video signal output terminal 19V is connected to the display 3 so that video based on the video signal is displayed on a display screen 3D of the display 3.

The video decoding output unit 16 is also supplied with subtitle information in a language selected by the system control unit 100 in a manner described below through a subtitle control unit 23. Upon receiving the subtitle information through the subtitle control unit 23, the video decoding output unit 16 superimposes a subtitle on the video on the basis of time position information included in the subtitle information, and outputs a video signal. The time position information indicates a time at which a subtitle is superimposed on played back video.

The audio decoding output unit 17 decodes the audio data to generate a playback audio signal, and outputs the generated playback audio signal to an audio signal output terminal 19A. The audio signal output terminal 19A is connected to a loudspeaker 4 so that sounds including voiced speech are played back from the playback audio signal via the speaker 4.

The audio decoding output unit 17 is also supplied with an audio playback control signal for controlling playback of audio data in a language selected by the system control unit 100 in a manner described below through an audio control unit 24. Upon receiving the audio playback control signal through the audio control unit 24, the audio decoding output unit 17 decodes the audio data in the language selected by the audio playback control signal and outputs a playback audio signal.

The additional information supplied to the additional information detection unit 20 from the playback processing unit 15 includes position information regarding data recorded on the recording medium, information regarding links between recorded data items, such as link information and time information, a plurality of types of subtitle information (including information indicating a time point at which a subtitle is superimposed on the video), and information regarding a language in which audio information is recorded.

The additional information detection unit 20 detects the additional information and passes the detected information to the system control unit 100. The system control unit 100 uses the additional information, namely, the position information regarding data recorded on the recording medium, the link information, and the time information, to perform position control to cause the optical pickup 13 to scan on the DVD 2 and to perform seek control (to cause the optical pickup 13 to move in a radial direction of the DVD 2).

The system control unit 100 further selects desired subtitle information from among the plurality of types of subtitle information in the additional information, which is based on whether the current mode is the normal playback mode or the language-learning playback mode, and supplies the selected subtitle information to the video decoding output unit 16 through the subtitle control unit 23.

The system control unit 100 further refers to the additional information, namely, the information regarding a language in which audio information is recorded, to select audio information in a desired language which is based on whether the current mode is the normal playback mode or the language-learning playback mode, and supplies a signal for controlling playback of the audio information in the selected language to the audio decoding output unit 17 through the audio control unit 24.

The optical pickup 13 can be driven by a seek drive unit 21 to move (or seek) in the radial direction of the DVD 2.

A playback position control signal is supplied to the seek drive unit 21 from a playback position control unit 22. In response to an instruction signal from the system control unit 100 indicating a desired playback position from which data is to be read by the optical pickup 13, the playback position control unit 22 generates a playback position control signal including a seek drive control signal for allowing the seek drive unit 21 to drive movement in the radial direction of the DVD 2 so that the optical pickup 13 can reach the desired playback position.

In this embodiment, a user input interface (I/F) unit 25 receives a remote control operation instruction signal from a remote control transmitter 26 via, for example, infrared communication, and passes the remote control instruction signal to the system control unit 100. The system control unit 100 analyzes the received remote control operation signal to determine which operation button on the remote control transmitter 26 has been operated, and performs control to execute a functional process specified by the determined operation button.

In this embodiment, the remote control transmitter 26 includes a mode switching button (not shown) for switching between the normal playback mode and the language-learning playback mode. When the user operates the mode switching button on the remote control transmitter 26 and selects the normal playback mode, the system control unit 100 performs a playback process similar to that of the related art on the DVD 2. When the user selects the language-learning playback mode, the system control unit 100 performs a playback process in the language-learning playback mode according to this embodiment, as described below.

When an operation instruction signal for increasing the playback speed or reducing the playback speed is received from the remote control transmitter 26, a playback speed control unit 27 implements fast playback or slow playback by controlling reading of the video data and audio data output from the playback processing unit 15 in response to an instruction from the system control unit 100.

If it is determined that fast playback or slow playback has been instructed, the system control unit 100 controls the playback position control unit 22 to perform seek control of the optical pickup 13 for fast playback or slow playback.

The playback apparatus 1 of this embodiment further includes function units for the language-learning playback mode. In this embodiment, referring to FIG. 1, the function units for the language-learning playback mode may include a language-learning chapter generation unit 31, a language-learning setting information storage unit 32, a language-learning dictionary storage unit 33, and a graphical user interface (GUI) generation output unit 34.

In the language-learning playback mode, the language-learning chapter generation unit 31 receives subtitle information in a target language to be learned, which is selected by the system control unit 100, from the system control unit 100. Then, the language-learning chapter generation unit 31 detects a start point and an end point of a superimposition section as a start point and an end point of a segmented section (hereinafter referred to as a “chapter”) for language learning to generate a language-learning chapter. The superimposition section is a section where a subtitle included in the subtitle information in the target language is superimposed on video.

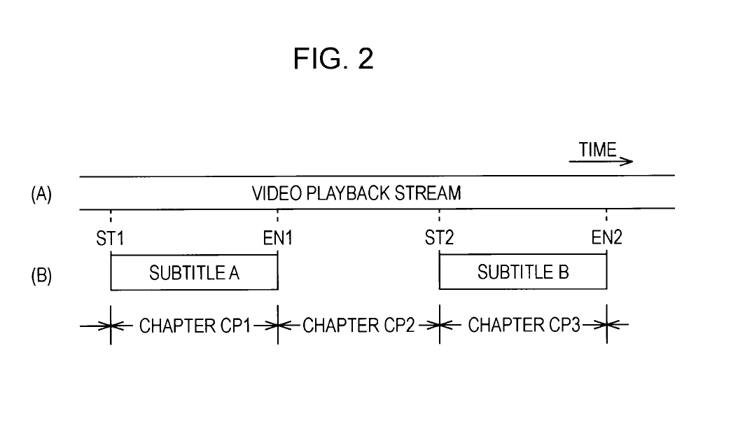

For example, in a video playback stream shown in part (A) of FIG. 2, a subtitle A is superimposed in a section starting at a point ST1 and ending at a point EN1 and a subtitle B is superimposed in a section starting at a point ST2 and ending at a point EN2. In this case, the language-learning chapter generation unit 31 generates chapters so that a chapter CP1 starts at the point ST1 and ends at the point EN1, a chapter CP2 starts at the point EN1 and ends at the point ST2, a chapter CP3 starts at the point ST2 and ends at the point EN2, and so forth. That is, the language-learning chapter generation unit 31 generates sections where no subtitles are superimposed on the video, as well as sections where subtitles are superimposed, as chapters. In other words, start points and end points of subtitle superimposition sections may be start points and end points of chapters, respectively, or vice versa. A start point and an end point of a chapter are collectively referred to as “chapter points”.

The language-learning chapter generation unit 31 stores start point and end point data of each generated chapter in a buffer memory (not shown) (which may be, for example, a built-in buffer memory of the language-learning chapter generation unit 31). The start point and end point data of each chapter is stored for a period from the start of the language-learning playback mode after the DVD 2 is placed in the playback apparatus 1 to the end of the language-learning playback mode.

The language-learning setting information storage unit 32 stores information set in association with the language-learning playback mode, including an input setting of a native language and an input setting of a target language to be learned. The native language set and registered in the language-learning setting information storage unit 32 may be a pre-registered language of a country where the playback apparatus 1 is to be sold or a native language registered in advance by the user.

The language-learning dictionary storage unit 33 stores dictionary data containing the definitions or meanings of words of the target language which are given in the native language. Dictionary data for languages corresponding to languages which will be available to be learned is written in the language-learning dictionary storage unit 33 in advance.

The language-learning dictionary storage unit 33 may be formed of a storage device using a removable recording medium such as a memory card. That is, the language-learning dictionary storage unit 33 may be implemented by, for example, a memory card reader capable of accommodating a memory card. In this case, the user merely places a memory card for a language that the user desires to learn in the memory card reader that can implement the language-learning dictionary storage unit 33, instead of storing dictionary data in the language-learning dictionary storage unit 33 in advance.

When the playback mode is switched to the language-learning playback mode, the GUI generation output unit 34 generates GUI information for allowing the user to perform an operation input while learning a language, and supplies the generated GUI information to the combining unit 18 to superimpose the GUI information on playback video signals.

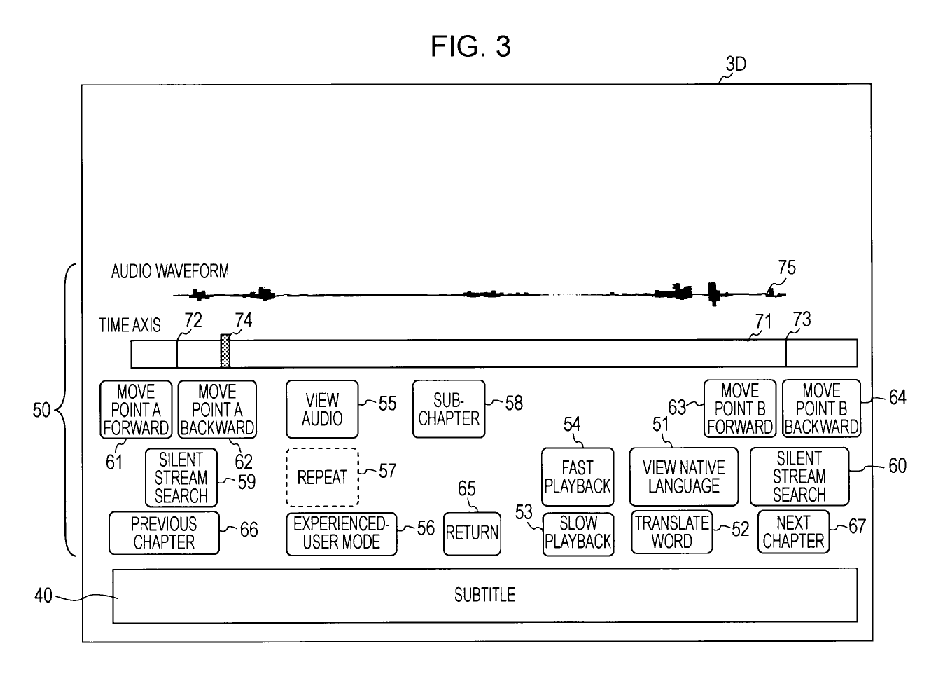

FIG. 3 shows an example of a language-learning GUI in this embodiment. In FIG. 3, a language-learning GUI is displayed on the display screen 3D of the display 3. A subtitle is displayed in a subtitle area 40 at the bottom of the screen 3D. In this embodiment, a language-learning GUI display area 50 for displaying the language-learning GUI is located above the subtitle area 40.

The language-learning GUI display area 50 includes a time axis bar 71 for providing a visual indication of one section of a language-learning chapter. As with the time axis bar 71, time flows from left to right. The time axis bar 71 has a left vertical line 72 indicating a start point (hereinafter also referred to as a “point A”) of the chapter and a right vertical line 73 indicating an end point (hereinafter also referred to as a “point B”) of the chapter.

A vertical bar 74 is configured to slide along the time axis bar 71 in accordance with video content being played back, and indicates a current playback position in the chapter.

An audio waveform 75 for simulating sounds played back in the chapter is displayed above the time axis bar 71. As described below, the audio waveform 75 is configured to be displayed on the display screen 3D only when an explicit display instruction is given by the user.

Below the time axis bar 71 provided are various icon buttons that can be used by the user in the language-learning playback mode so that the playback apparatus 1 is configured to perform a process associated with an icon button operated in response to an icon button operation instruction received from the remote control transmitter 26.

In this embodiment, the icon buttons may include a “View Native Language” button 51, a “Translate Word” button (dictionary button) 52, a “Slow Playback” button 53, a “Fast Playback” button 54, a “View Audio” button 55, an “Advanced-User Mode” button 56, a “Repeat” button 57, a “Subchapter” button 58, “Silent Stream Search” buttons 59 and 60, a “Move Point A Forward” button 61, a “Move Point A Backward” button 62, a “Move Point B Forward” button 63, a “Move Point B Backward” button 64, a “Return” button 65, a “Previous Chapter” button 66, and a “Next Chapter” button 67.

When the “View Native Language” button 51 is operated by the user, the subtitle displayed in the subtitle area 40 is changed from that in the target language to be learned to that in a language registered as the native language. In this embodiment, when the “Return” button 65 is operated by the user, the subtitle in the subtitle area 40 is returned from that in the native language to that in the target language to be learned.

When the “Translate Word” button 52 is operated by the user, the definitions or meanings of a word in the subtitle area 40 which are given in the native language is displayed. Alternatively, when the “Translate Word” button 52 is operated, the definitions or meaning of all words currently appearing in the subtitle area 40 may be displayed. Alternatively, for example, in accordance with playback, subtitle characters in the subtitle area 40 may be displayed in such a manner that characters of a word currently being spoken are highlighted so as to be distinguishable from other characters, and only the definitions or meanings of the word distinguished from other words may be displayed when the “Translate Word” button 52 is operated.

When the “Slow Playback” button 53 is operated by the user, the playback speed is reduced. In other words, video and audio playback is performed in such a manner that the utterance speed of speech being uttered is reduced. The “Slow Playback” button 53 can be used when the user desires to listen to utterances at a low utterance speed during language learning because it is difficult to catch.

When the “Fast Playback” button 54 is operated by the user, the playback speed is increased. In other words, video and audio playback is performed in such a manner that the utterance speed of speech being uttered is increased. The “Fast Playback” button 54 can be used when the user desires to listen to utterances at a higher speed because of the increased level of in learning achievement.

The “View Audio” button 55 is used to turn on or off the display of the audio waveform 75. Each time the “View Audio” button 55 is operated, the display of the audio waveform 75 is alternately turned on and off.

The “Advanced-User Mode” button 56 is provided for the following purposes. In this embodiment, in the language-learning playback mode, chapter sections with superimposed subtitles may be repeatedly played back, as described below. Automatic repeated playback of such chapter sections without causing the user to perform a repeating operation would be effective to learn a language.

An advanced user, however, may not necessarily repeat all chapters. To address this situation, when the “Advanced-User Mode” button 56 is operated, instead of automatically repeating chapter sections, only a chapter desired by the user is repeated. In other words, when the “Advanced-User Mode” button 56 is operated, automatic repeated playback of chapter sections is not basically performed only a chapter for which an instruction has been given by the user to repeat the playback is repeatedly played back.

In this embodiment, therefore, when the “Advanced-User Mode” button 56 is operated, the “Repeat” button 57 appears to allow a repeating instruction from the user. As indicated by a dotted line shown in FIG. 3, when the “Advanced-User Mode” button 56 is not operated, the “Repeat” button 57 does not appear in the language-learning GUI display area 50 to prevent the operation of the “Repeat” button 57.

The “Subchapter” button 58 is used to generate a subchapter in a portion of a chapter to repeatedly play back the subchapter. For example, the “Subchapter” button 58 is used when the user desires to repeatedly listen to a portion of a long chapter.

The “Silent Stream Search” buttons 59 and 60 are used to correct for a deviation between a start point (point A) and end point (point B) of a chapter and those of actual playback audio. When the “Silent Stream Search” button 59 or 60 is operated, the system control unit 100 detects a silent period from playback audio data, and corrects a start point (point A) and end point (point B) of a chapter so as to be shifted in the silent period. The “Silent Stream Search” button 59 is used to correct a start point (point A) of a chapter and the “Silent Stream Search” button 60 is used to correct an end point (point B) of the chapter.

The “Move Point A Forward” button 61, the “Move Point A Backward” button 62, the “Move Point B Forward” button 63, and the “Move Point B Backward” button 64 are also used to help the user correct a start point (point A) and end point (point B) of a chapter. Note that, unlike the “Silent Stream Search” buttons 59 and 60, the buttons 61 to 64 can help the user manually, instead of automatically, correct a start point (point A) and end point (point B) of a chapter.

The “Return” button 65 is an icon button used to return the conditions, which have been changed as a result of the operation performed using various icon buttons, to the original conditions.

The “Previous Chapter” button 66 and the “Next Chapter” button 67 are icon buttons for transition from the repeated playback of a chapter described above to the playback of another chapter. When the “Previous Chapter” button 66 is operated during repeated playback of a chapter, a chapter preceding the chapter is repeatedly played back. When the “Next Chapter” button 67 is operated during repeated playback of a chapter, a chapter following the chapter is repeatedly played back.

The operation of the playback apparatus 1 of this embodiment will now be described with reference to a flowchart.

In this embodiment, as described above, a language-learning playback mode is provided in addition to a normal playback mode, and the remote control transmitter 26 serving as an input operation unit includes a mode switching button adapted to switch between the normal playback mode and the language-learning playback mode. The playback apparatus 1 of this embodiment is configured to automatically set an audio language and a subtitle language in accordance with the switching between the playback modes using the mode switching button.

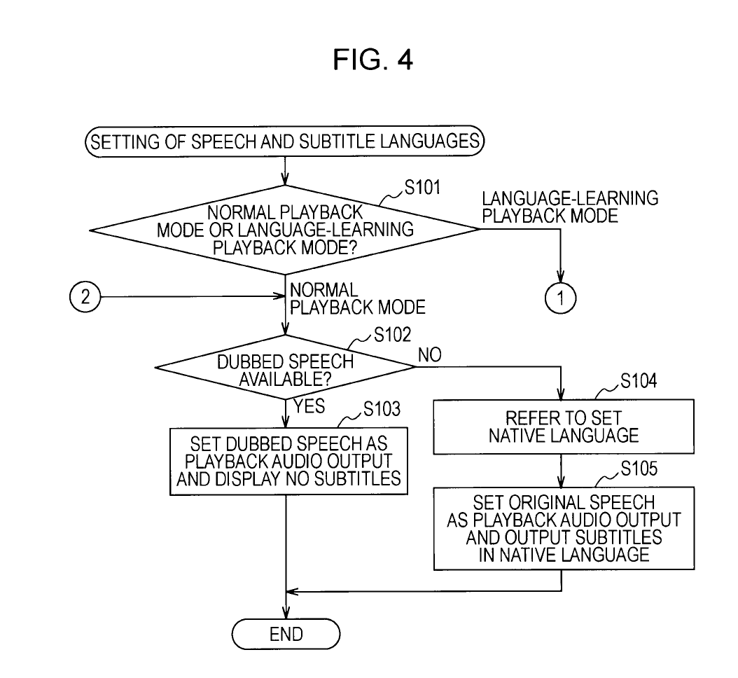

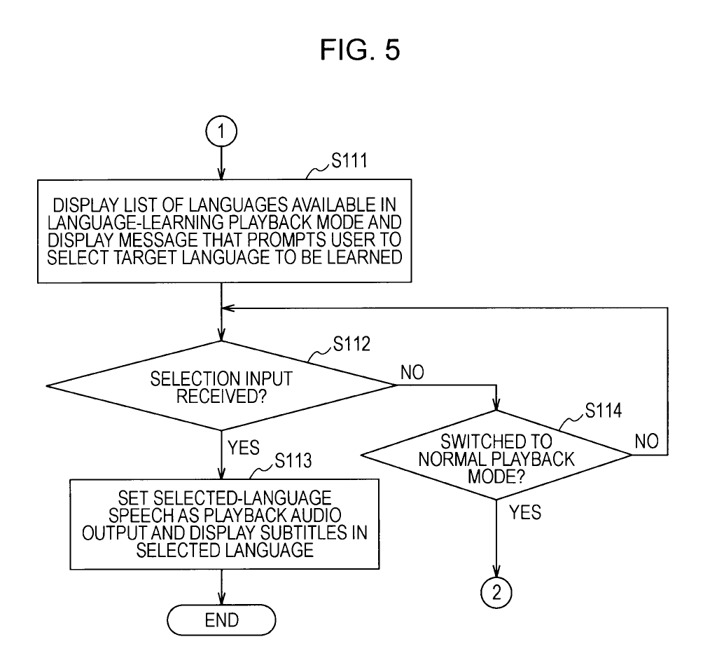

FIGS. 4 and 5 show a flowchart showing an example process for setting an audio language and a subtitle language. The processing of individual steps of the flowchart may be performed by the system control unit 100. The flowchart starts after the playback mode is switched to the language-learning playback mode and after the DVD 2 is placed in the playback apparatus 1.

In this example, it is assumed that the DVD 2 has recorded thereon audio in the original language and dubbed audio in several other languages, as well as corresponding subtitle information for the individual languages.

First, the system control unit 100 determines whether the normal playback mode or the language-learning playback mode has been set using the mode switching button (step S101). If it is determined in step S101 that the normal playback mode has been set, the system control unit 100 refers to the additional information supplied from the additional information detection unit 20 to determine whether or not dubbed audio is available (step S102).

If it is determined in step S102 that dubbed audio is available, the system control unit 100 instructs the audio decoding output unit 17 through the audio control unit 24 to set the dubbed audio as a playback audio signal, and also instructs the subtitle control unit 23 to display no subtitles (step S103). Then, the setting processing routine ends.

If it is determined in step S102 that dubbed audio is not available, the system control unit 100 refers to the native language version set and registered in the language-learning setting information storage unit 32 (step S104). Then, the system control unit 100 instructs the audio decoding output unit 17 through the audio control unit 24 to set the original audio as a playback audio signal, and also instructs the subtitle control unit 23 to display subtitles in the native language so as to be superimposed on the video (step S105). Then, the setting processing routine ends.

If it is determined in step S101 that the language-learning playback mode has been set, in this example, the system control unit 100 refers to the additional information supplied from the additional information detection unit 20 to display a list of languages available in the language-learning playback mode, and displays a message for prompting the user to select a target language to be learned (step S111 shown in FIG. 5).

Then, the system control unit 100 determines whether or not an input of a selected target language to be learned has been received from the user (step S112). If it is determined that an input of a selected target language to be learned has been received, the system control unit 100 instructs the audio decoding output unit 17 through the audio control unit 24 to set the audio in the selected language as a playback audio signal, and also instructs the subtitle control unit 23 to display subtitles in the selected language so as to be superimposed on the video (step S113). Then, the setting processing routine ends.

If it is determined in step S112 that an input of a selected target language to be learned has not been received from the user, the system control unit 100 determines whether or not the language-learning playback mode has been switched to the normal playback mode by the user (step S114). If it is determined that the language-learning playback mode has not been switched, the system control unit 100 returns to step S112, and repeats the processing after step S112. If it is determined in step S114 that the language-learning playback mode has been switched to the normal playback mode, the system control unit 100 returns to step S102 and repeats the processing after step S102.

In the example described above, the DVD 2 has recorded thereon a plurality of dubbed language versions and a plurality of types of subtitle information corresponding thereto. In general, commercially available DVDs containing film content may often have recorded thereon audio signals and subtitle information for an original language version and dubbed audio and subtitle information for a version of a native language of a country where the DVDs are to be sold.

For such DVDs, in the language-learning playback mode, the system control unit 100 may instruct the audio decoding output unit 17 through the audio control unit 24 to set the audio in the original language as a playback audio signal, without performing the operation in step S111 of prompting the user to set a target language to be learned, and may further instruct the subtitle control unit 23 to display subtitles in the original language so as to be superimposed on the video.

In this setting operation, the user can merely switch the playback mode to the language-learning playback mode, thereby playing back audio in a target language to be learned and displaying subtitles in the target language so as to be superimposed on the played back video before starting language learning.

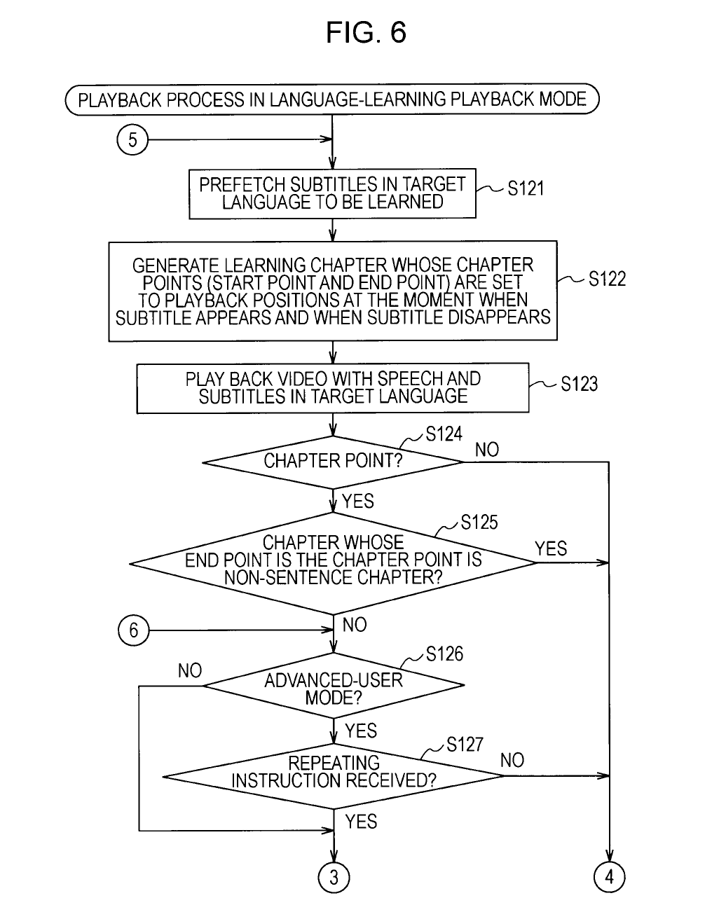

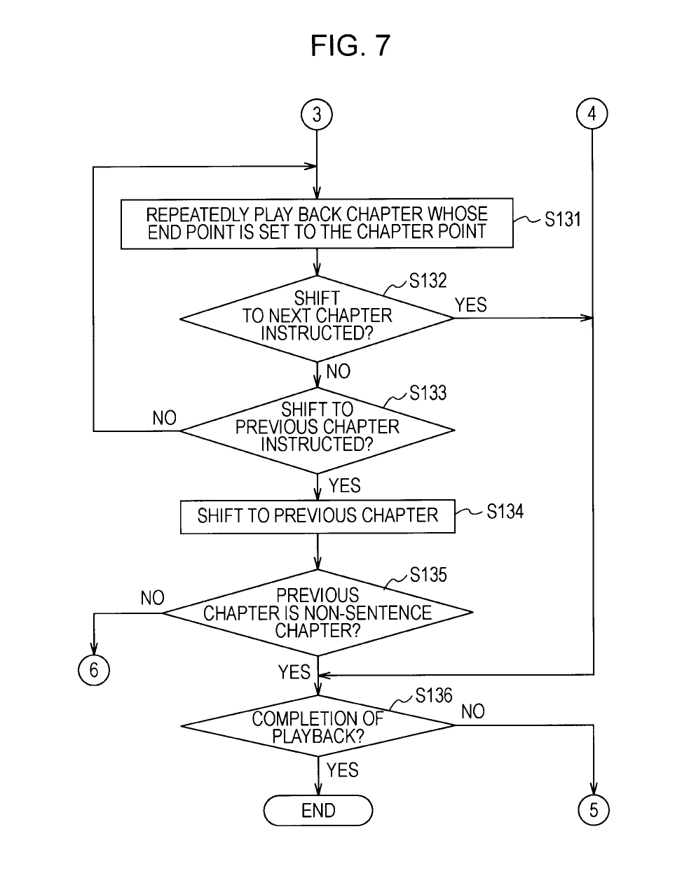

The playback processing operation in the language-learning playback mode will now be described with reference to a flowchart shown in FIGS. 6 and 7.

First, the system control unit 100 prefetches target-language subtitle information in a target language to be learned, and passes the target-language subtitle information obtained from the additional information detection unit 20 to the language-learning chapter generation unit 31 (step S121).

The language-learning chapter generation unit 31 detects playback position information regarding a playback position at the moment when a subtitle is superimposed on video (at the moment when the subtitle appears) and a playback position at the moment when the superimposition of the subtitle is completed (at the moment when the subtitle disappears from the video) from the obtained subtitle information. As described above, the language-learning chapter generation unit 31 sets the detected playback positions as chapter points (start point and end point) of a learning chapter to generate a learning chapter (hereinafter referred to simply as a “chapter”), and stores information regarding the start point and end point of the generated chapter (step S122).

The system control unit 100 plays back video content from the DVD 2 during the processing of steps S121 and S122. Specifically, the system control unit 100 performs control to set the audio in the target language as a playback audio signal and to display subtitles in the target language so as to be superimposed on video based on playback video signals in synchronization with the chapter generated in step S122 (step S123).

Then, the system control unit 100 monitors information regarding a playback position in the additional information currently being played back to determine whether or not the playback position has reached a chapter point (step S124). If it is determined that the playback position has not yet reached a chapter point, it is determined whether or not playback is to be completed due to the completion up to the end of the video content or in response to a user's operation of stopping the playback of the video content (step S136 shown in FIG. 7). If it is determined that playback is to be completed, the processing routine ends. If it is determined that playback is not to be completed, the system control unit 100 returns to step S121, and repeats the playback of the video content while generating a chapter.

If it is determined in step S124 that the playback position has reached a chapter point, the system control unit 100 determines whether or not a chapter whose end point is the chapter point includes a subtitle to determine whether or not the chapter is a chapter that includes no spoken utterance sentences in the video content (hereinafter referred to as a “non-sentence chapter”) (step S125).

If it is determined in step S125 that the chapter is a non-sentence chapter, the system control unit 100 determines that the current chapter is not a target chapter for language learning, and then proceeds to step S136. If it is determined that playback is to be completed, the processing routine ends. If it is determined that playback is not to be completed, the system control unit 100 returns to step S121, and repeats the playback of the video content while generating a chapter.

If it is determined in step S125 that the chapter is not a non-sentence chapter but a chapter including an utterances and a subtitle, the system control unit 100 determines whether or not the advanced-user mode currently has been set in response to the operation of the “Advanced-User Mode” button 56 (step S126). If it is determined that the advanced-user mode is not set, the system control unit 100 performs control to repeatedly play back a chapter whose end point is the chapter point (step S131 shown in FIG. 7).

Then, the system control unit 100 determines whether or not an instruction has been received to shift the playback position to the next chapter in response to the operation of the “Next Chapter” button 67 (step S132). If it is determined that an instruction has been received to shift the playback position to the next chapter, the processing routine proceeds to step S136. If it is determined that playback is to be completed, the processing routine ends. If it is determined that playback is not to be completed, the system control unit 100 returns to step S121, and plays back the video content of the next chapter while generating a further next chapter.

If it is determined in step S132 that an instruction has not been received to shift the playback position to the next chapter, the system control unit 100 determines whether or not an instruction has been received to shift the playback position to the previous chapter in response to the operation of the “Previous Chapter” button 66 (step S133). If it is determined that an instruction has not been received to shift the playback position to the previous chapter, the system control unit 100 returns to step S131, and continuously repeats the playback of the chapter.

If it is determined in step S133 that an instruction has been received to shift the playback position to the previous chapter, the system control unit 100 shifts the playback position to the previous chapter (step S134). Then, the system control unit 100 determines whether or not the previous chapter is a non-sentence chapter (step S135). If it is determined that the previous chapter is a non-sentence chapter, the routine proceeds to step S136. If it is determined that playback is to be completed, the processing routine ends. If it is determined that playback is not to be completed, the system control unit 100 returns to step S121, and repeats the playback of the video content while generating a chapter.

If it is determined in step S135 that the previous chapter is not a non-sentence chapter, the system control unit 100 jumps to step S126, and repeats the processing after step S126 described above.

If it is determined in step S126 that the advanced-user mode has been set, the system control unit 100 determines whether or not a repeating instruction has been received in response to the operation of the “Repeat” button 57 (step S127).

Then, if it is determined in step S127 that no repeating instruction has been received, the system control unit 100 proceeds to step S136 without repeatedly playing back the chapter. If it is determined that playback is to be completed, the processing routine ends. If it is determined that playback is not to be completed, the system control unit 100 returns to step S121, and repeats the playback of the video content while generating a chapter.

If it is determined in step S127 that a repeating instruction has been received, the system control unit 100 proceeds to step S131 to repeatedly play back the chapter, and executes the processing after step S131.

In the example shown in FIGS. 6 and 7 described above, a learning chapter is generated during the playback of video content. Alternatively, prior to the playback of video content, all learning chapters for the video content may be generated and stored.

A process for a GUI-based user input operation in the language-learning playback mode will now be described.

As shown in FIG. 3, as described above, in the language-learning playback mode, a language-learning GUI is displayed on the display screen 3D to perform control so that the system control unit 100 receives an operation input using the icon buttons 51 to 67 described above and executes a corresponding process.

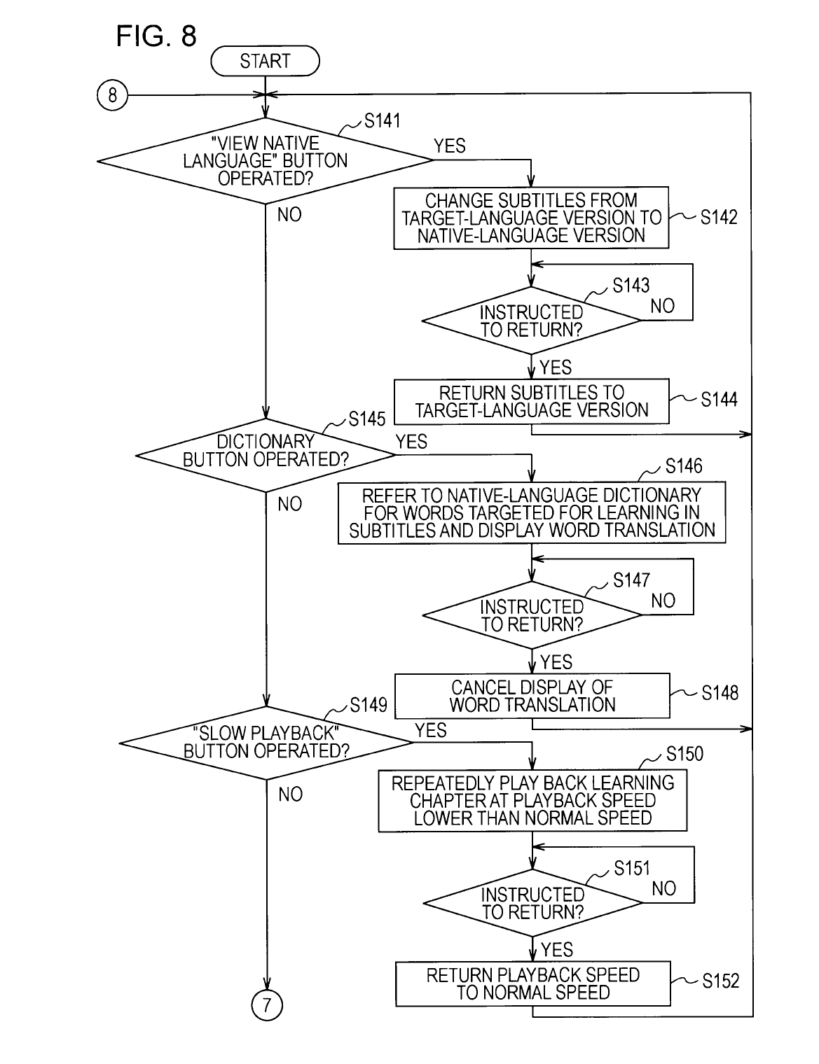

FIGS. 8 to 13 show a flowchart showing an example of the control operation of the system control unit 100 in response to an operation input using the icon buttons 51 to 67 of the language-learning GUI.

In this example, first, the system control unit 100 determines whether or not the “View Native Language” button 51 has been operated (step S141). If it is determined that the “View Native Language” button 51 has been operated, the system control unit 100 refers to the native language registered in the language-learning setting information storage unit 32 to recognize the native language. Then, the system control unit 100 performs control to change subtitles to be superimposed on played back video from subtitles in a target language to be learned to subtitles in the native language (step S142).

Then, the system control unit 100 monitors the operation of the “Return” button 65 (step S143), and continuously displays the subtitles superimposed in the native language until the “Return” button 65 has been operated. If it is determined that the “Return” button 65 has been operated, the system control unit 100 performs control to return the subtitles to be superimposed on the played back video to the subtitles in the target language (step S144). Then, the system control unit 100 returns to step S141, and repeats the processing after step S141.

If it is determined in step S141 that the “View Native Language” button 51 is not operated, the system control unit 100 determines whether or not the “Translate Word” button (dictionary button) 52 has been operated (step S145). If it is determined that the “Translate Word” button 52 has been operated, in this example, the system control unit 100 refers to the native-language dictionary in the language-learning dictionary storage unit 33 to search for all words targeted for learning in the displayed subtitles, and displays the native-language translation of the individual words (step S146). During this time, in this example, the system control unit 100 suspends (or pauses) the playback of the video content during this processing.

Then, the system control unit 100 monitors the “Return” button 65 (step S147), and allows continuous display of the word translation and continuation of the pause state until the “Return” button 65 has been operated. If it is determined that the “Return” button 65 has been operated, the display of the word translation and the pause state are canceled (step S148). Then, the system control unit 100 returns to step S141, and repeats the processing after step S141.

If it is determined in step S145 that the “Translate Word” button 52 is not operated, the system control unit 100 determines whether or not the “Slow Playback” button 53 has been operated (step S149). If it is determined that the “Slow Playback” button 53 has been operated, the system control unit 100 repeatedly plays back the chapter at a playback speed lower than the normal speed (step S150).

Then, the system control unit 100 monitors the operation of the “Return” button 65 (step S151), and continues the repeated playback of chapters at the playback speed lower than the normal speed until the “Return” button 65 has been operated. If it is determined that the “Return” button 65 has been operated, the system control unit 100 performs control to return the playback speed to the normal playback speed (step S152). Then, the system control unit 100 returns to step S141, and repeats the processing after step S141.

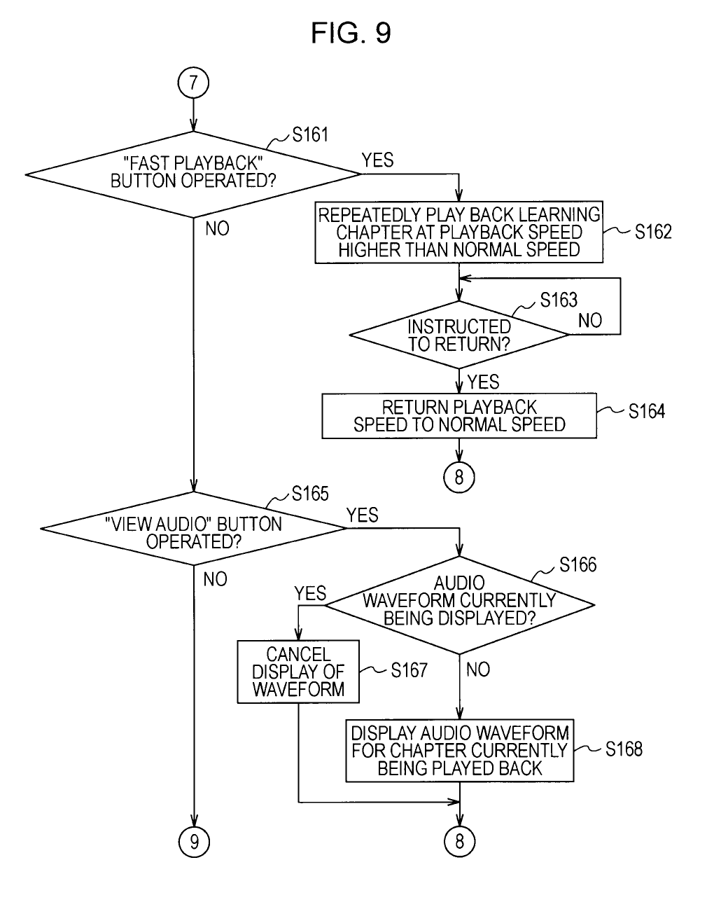

If it is determined in step S149 that the “Slow Playback” button 53 is not operated, the system control unit 100 determines whether or not the “Fast Playback” button 54 has been operated (step S161 shown in FIG. 9). If it is determined that the “Fast Playback” button 54 has been operated, the system control unit 100 repeatedly plays back the chapter at a playback speed higher than the normal speed (step S162).

Then, the system control unit 100 monitors the operation of the “Return” button 65 (step S163), and continues the repeated playback of chapters at the playback speed higher than the normal speed until the “Return” button 65 has been operated. If it is determined that the “Return” button 65 has been operated, the system control unit 100 performs control to return the playback speed to the normal playback speed (step S164). Then, the system control unit 100 returns to step S141, and repeats the processing after step S141.

If it is determined in step S161 that the “Fast Playback” button 54 is not operated, the system control unit 100 determines whether or not the “View Audio” button 55 has been operated (step S165). If it is determined that the “View Audio” button 55 has been operated, it is determined whether or not the audio waveform 75 is currently being displayed in the language-learning GUI (step S166). If it is determined that the audio waveform 75 is currently being displayed, the display of the audio waveform 75 is canceled (step S167). If it is determined that the audio waveform 75 is not currently being displayed, the audio waveform 75 for the chapter currently being played back is displayed in the language-learning GUI (step S168). Then, the system control unit 100 returns to step S141, and repeats the processing after step S141.

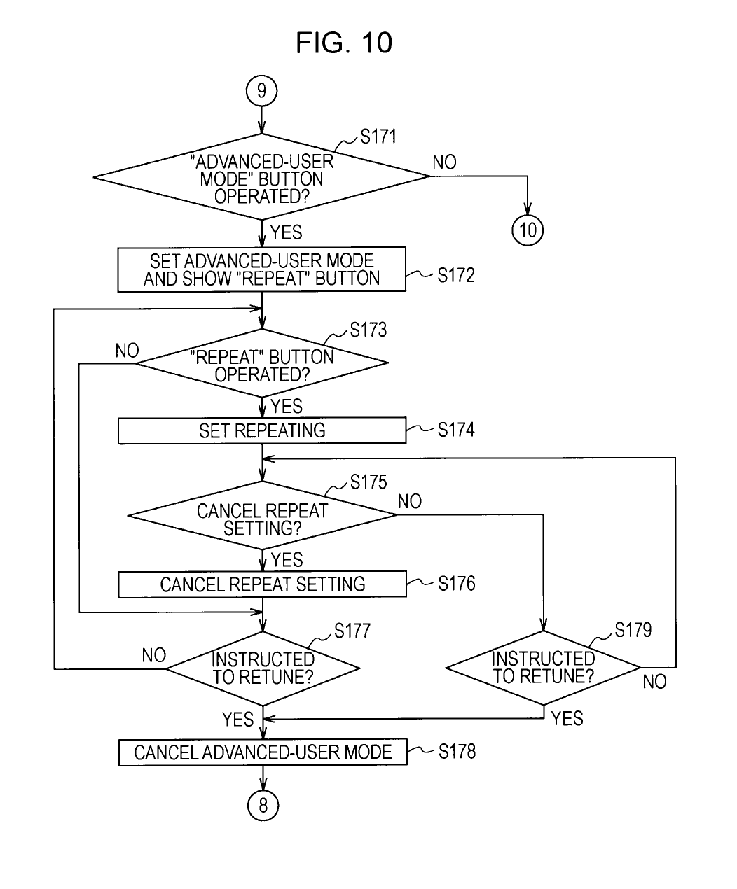

If it is determined in step S165 that the “View Audio” button 55 is not operated, the system control unit 100 determines whether or not the “Advanced-User Mode” button 56 has been operated (step S171 shown in FIG. 10). If it is determined that the “Advanced-User Mode” button 56 has been operated, the system control unit 100 sets the playback apparatus 1 to the advanced-user mode, and causes the “Repeat” button 57 to appear in the language-learning GUI (step S172).

Then, the system control unit 100 determines whether or not the “Repeat” button 57 has been operated (step S173). If it is determined that the “Repeat” button 57 has been operated, the system control unit 100 performs a setting to repeat the chapter (step S174). After step S174, the system control unit 100 determines whether or not the operation of canceling the repeat setting has been performed by, for example, operating the “Repeat” button 57 again (step S175). If it is determined that the operation of canceling the repeat setting has been performed, the repeat setting is canceled (step S176).

After step S176, the system control unit 100 monitors the operation of the “Return” button 65 (step S177). If it is determined that the “Return” button 65 is not operated, the system control unit 100 returns to step S173, and repeats the processing after step S173.

If it is determined in step S177 that the “Return” button 65 has been operated, the system control unit 100 cancels the advanced-user mode and causes the “Repeat” button 57 to be hidden again (step S178). Then, the system control unit 100 returns to step S141, and repeats the processing after step S141.

If it is determined in step S175 that the operation of canceling the repeat setting has not been performed, the system control unit 100 monitors the operation of the “Return” button 65 (step S179). If it is determined that the “Return” button 65 is not operated, the system control unit 100 returns to step S175, and repeats the processing after step S175.

Further, if it is determined in step S173 that the “Repeat” button 57 is not operated, the system control unit 100 jumps to step S177, and repeats the processing after step S177.

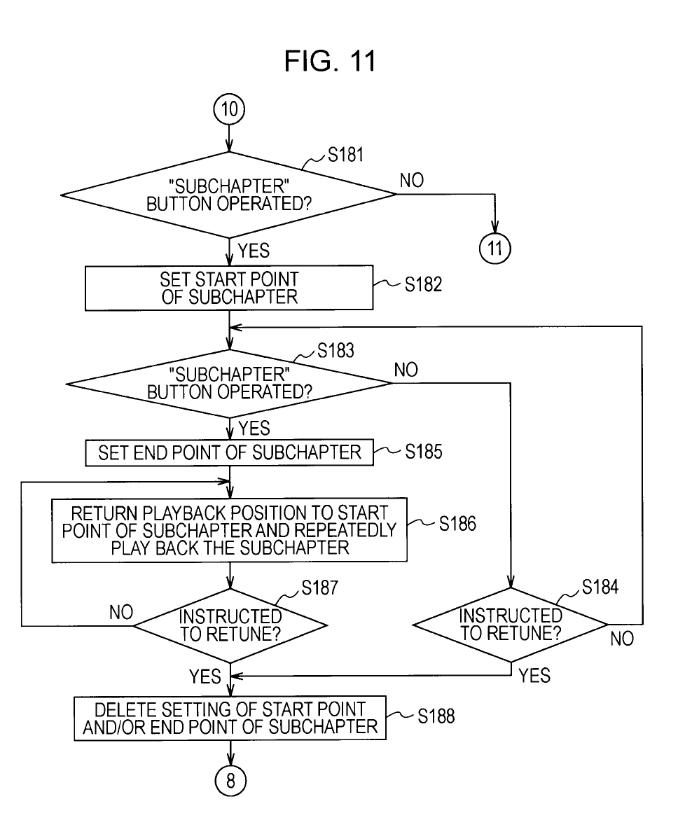

If it is determined in step S171 that the “Advanced-User Mode” button 56 is not operated, the system control unit 100 determines whether or not the “Subchapter” button 58 has been operated (step S181 shown in FIG. 11). If it is determined that the “Subchapter” button 58 has been operated, the system control unit 100 sets a playback position at which the “Subchapter” button 58 was operated as a start point of a subchapter in the chapter, and stores information regarding the set playback position (step S182).

Then, the system control unit 100 determines whether or not the “Subchapter” button 58 has been operated (step S183). If it is determined that the “Subchapter” button 58 has been operated, the system control unit 100 sets a playback position at which the “Subchapter” button 58 was operated as an end point of the subchapter in the chapter, and stores information regarding the set playback position (step S185).

After step S185, the system control unit 100 returns the playback position to the start point of the subchapter set in step S182, and repeatedly plays back the subchapter (step S186).

After step S186, the system control unit 100 monitors the operation of the “Return” button 65 (step S187). If it is determined that the “Return” button 65 is not operated, the system control unit 100 returns to step S186, and continuously repeatedly plays back the subchapter.

If it is determined in step S187 that the “Return” button 65 has been operated, the system control unit 100 deletes the setting of the start point and end point of the subchapter, and terminates the repeated playback of the subchapter (step S188). Thereafter, unless the advanced-user mode is set, every chapter is repeatedly played back. Then, the system control unit 100 returns step S141, and repeats the processing after step S141.

If it is determined in step S183 that the “Subchapter” button 58 used to instruct that the end point of the subchapter be set is not operated, the system control unit 100 monitors the operation of the “Return” button 65 (step S184). If it is determined that the “Return” button 65 is not operated, the system control unit 100 returns step S183, and continuously monitors the operation of the “Subchapter” button 58.

If it is determined in step S184 that the “Return” button 65 has been operated, the system control unit 100 cancels the setting of the start point of the subchapter set in step S182, and clears the setting of the subchapter (step S188). Then, the system control unit 100 returns to step S141, and repeats the processing after step S141.

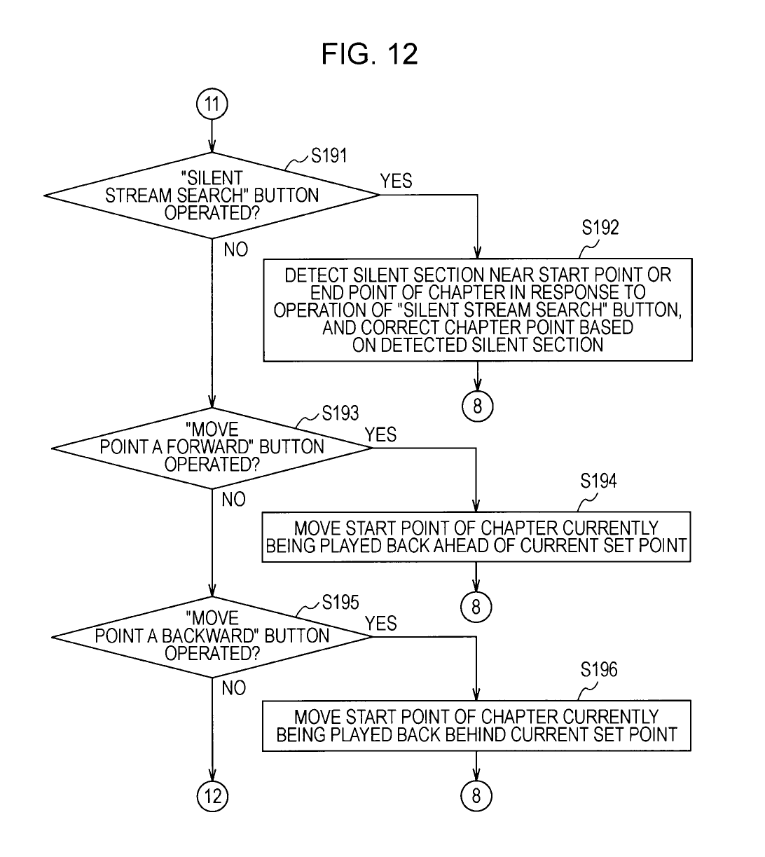

If it is determined in step S181 that the “Subchapter” button 58 is not operated, the system control unit 100 determines whether or not the “Silent Stream Search” button 59 or 60 has been operated (step S191 shown in FIG. 12). If it is determined that the “Silent Stream Search” button 59 or 60 has been operated, in response to the operation of the “Silent Stream Search” button 59 or 60, the system control unit 100 detects a silent period near the start point or end point of the chapter, and resets the start point or end point of the chapter to a new start point or end point based on the detected silent period. Then, the system control unit 100 stores the new start point or end point as a start point or end point of the chapter after correction (step S192).

Specifically, in step S192, when the operated icon button is the “Silent Stream Search” button 59, a silent period near the start point of the chapter currently being played back is searched for and detected, and the start point is reset to a certain time point in the detected silent period, for example, an intermediate time point, as a corrected start point of the chapter which is then stored. When the operated icon button is the “Silent Stream Search” button 60, a silent period near the end point of the chapter currently being played back is searched for and detected, and the end point is reset to a certain time point in the directed silent period, for example, an intermediate time point, as a corrected end point of the chapter which is then stored.

After step S192, the system control unit 100 returns to step S141, and repeats the processing after step S141.

If it is determined in step S191 that the “Silent Stream Search” button 59 or 60 is not operated, the system control unit 100 determines whether or not the “Move Point A Forward” button 61 has been operated (step S193). If it is determined that the “Move Point A Forward” button 61 has been operated, the system control unit 100 corrects the start point of the chapter currently being played back to be shifted ahead of or forward in time with respect to the current set point, and stores the corrected start point of the chapter (step S194).

After step S194, the system control unit 100 returns to step S141, and repeats the processing after step S141.

If it is determined in step S193 that the “Move Point A Forward” button 61 is not operated, the system control unit 100 determines whether or not the “Move Point A Backward” button 62 has been operated (step S195). If it is determined that “Move Point A Backward” button 62 has been operated, the system control unit 100 corrects the start point of the chapter currently being played back to be shifted behind or backward in time with respect to the current set point, and stores the corrected start point of the chapter (step S196).

After step S196, the system control unit 100 returns to step S141, and repeats the processing after step S141.

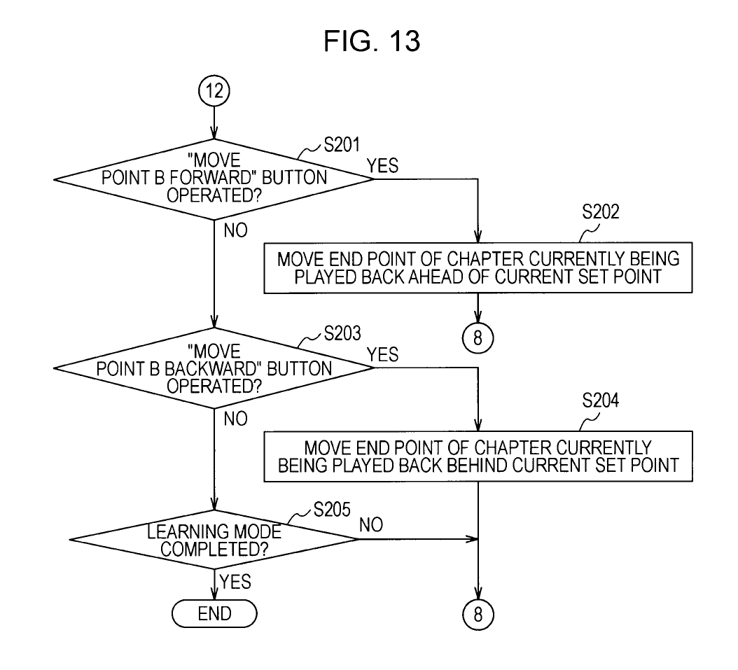

If it is determined in step S195 that the “Move Point A Backward” button 62 is not operated, the system control unit 100 determines whether or not the “Move Point B Forward” button 63 has been operated (step S201 shown in FIG. 13). If it is determined that the “Move Point B Forward” button 63 has been operated, the system control unit 100 corrects the end point of the chapter currently being played back to be shifted ahead of or forward in time with respect to the current set point, and stores the corrected end point of the chapter (step S202).

After step S202, the system control unit 100 returns to step S141, and repeats the processing after step S141.

If it is determined in step S201 that the “Move Point B Forward” button 63 is not operated, the system control unit 100 determines whether or not the “Move Point B Backward” button 64 has been operated (step S203). If it is determined that the “Move Point B Backward” button 64 has been operated, the system control unit 100 corrects the end point of the chapter currently being played back to be shifted behind or backward in time with respect to the current set point, and stores the corrected end point of the chapter (step S204).

After step S204, the system control unit 100 returns to step S141, and repeats the processing after step S141.

If it is determined in step S203 that the “Move Point B Backward” button 64 is not operated, the system control unit 100 determines whether or not the language-learning playback mode has been completed by, for example, switching the language-learning playback mode to the normal playback mode (step S205). If it is determined that the language-learning playback mode has been completed, the processing routine ends. If it is determined in step S205 that the language-learning playback mode has not been completed, the system control unit 100 returns to step S141, and repeats the processing after step S141.

According to the foregoing embodiment, advantageously, a user merely places a recording medium in a playback apparatus, the recording medium having recorded thereon video content containing subtitle information in an original language which the user desires to learn, and switches a playback mode of the playback apparatus from a normal playback mode to a language-learning playback mode, thereby automatically setting audio and subtitles in the language which the user desires to learn during the playback of the video content without causing the user to perform a special setting operation.

The recording medium having video content recorded thereon may be implemented by commercially available video content software. Advantageously, a user can select his or her favorite learning material from among a variety of learning materials of which the user will get less tired.

According to the foregoing embodiment, furthermore, a language-learning chapter is generated based on information regarding a start point and end point of a superimposition section of subtitle information corresponding to an utterance section, and the chapter is repeatedly played back without causing a user to perform an operation. This is effective for the user to learn a language.

The advanced-user mode is prepared for a user who has achieved a high language level. This allows repeated playback of only a chapter designated by the user, instead of repeating every chapter, and achieves high efficiency.

Furthermore, the “Slow Playback” button 53 and the “Fast Playback” button 54 are provided to reduce or increase the playback speed. With the use of the buttons 53 and 54, utterance information can be played back at a playback speed suitable for the learning level of the user. This is effective for the user to learn a language.

Furthermore, a chapter includes subchapters and repeated playback can be achieved on a subchapter-by-subchapter basis. This is effective for a user who desires to listen to a particular portion of a long chapter.

Furthermore, the “View Native Language” button 51 is operated during the playback of a language learning material, whereby subtitles in a foreign language can be changed to subtitles in a native language. This advantageously allows a user to immediately obtain the native language translation of an unknown word.

Furthermore, by operating a dictionary button, a user can view the definitions or meanings of a word of a foreign language in a chapter, and can therefore efficiently learn the language.

A further advantage is that even a deviation between a chapter generated from subtitle information and an actual utterance period can be corrected for using silent stream search or manual correction by a user to correct a start point and end point of the chapter.

### Other Embodiments or Modifications

In the foregoing embodiment, a display and a loudspeaker are separately provided. Alternatively, for example, a playback apparatus according to an embodiment of the present invention may be applied to a television receiver having a DVD playback function.

In the foregoing embodiment, a chapter is repeated until a user's operation is performed. Alternatively, after a chapter is repeated a predetermined number of times, subsequent chapters may be sequentially played back.

In the foregoing embodiment, a language-learning GUI is displayed all the time in the language-learning playback mode. Alternatively, a language-learning GUI may be displayed only in response to an instruction given by a user.

In the foregoing embodiment, a DVD is used as a recording medium having a learning material recorded thereon. Alternatively, other recording media such as a BD may be used. Other types of video content such as recordings of broadcast programs may be used.

It should be understood by those skilled in the art that various modifications, combinations, sub-combinations and alterations may occur depending on design requirements and other factors insofar as they are within the scope of the appended claims or the equivalents thereof.

What is claimed is:

1. A playback apparatus for playing back video information, audio information, and subtitle information from a recording medium, the recording medium having recorded thereon video information, audio information associated with the video information, and subtitle information corresponding to utterance information included in the audio information, the utterance information and the subtitle information being given in a plurality of languages, the playback apparatus comprising:
mode switching means for switching between a normal playback mode and a language-learning playback mode; and
control means for, when the language-learning playback mode is set by the mode switching means, playing back video information and audio information associated with the video information and reading, from the recording medium, subtitle information given in the same language as a language of utterance information included in the audio information to be played back to perform playback in which subtitles based on the subtitle information are superimposed and displayed on video based on the video information.

2. The playback apparatus according to claim 1,
wherein the recording medium has recorded thereon information regarding a start point and an end point of a superimposition time period for which a subtitle based on the subtitle information is superimposed on the video based on the video information,
wherein the playback apparatus further comprises segmented-section detecting means for reading the start point and the end point of the superimposition time period from the recording medium and detecting the read start point and end point as a start point and end point of a language-learning segmented section, and
wherein, in the language-learning playback mode, the control means performs control to repeatedly play back the segmented section detected by the segmented-section detecting means, the segmented section being a section in which the subtitle information is superimposed on the video based on the video information.

3. The playback apparatus according to claim 2, further comprising:
operation input receiving means for receiving a repeating operation input from a user,
wherein in the language-learning playback mode, the control means performs control to repeatedly play back the segmented section only when a repeating operation input is received at the operation input receiving means from the user.

4. The playback apparatus according to claim 1 or 2, further comprising:
native language storage means for receiving a setting of a native language of a user and storing subtitles in the native language in advance; and
operation input receiving means for receiving a native language instruction operation input from the user,
wherein in the language-learning playback mode, when a native language instruction operation input is received at the operation input receiving means from the user, the control means changes subtitles to be superimposed and displayed on the video to the subtitles in the native language stored in the native language storage means.

5. The playback apparatus according to claim 2, further comprising:
operation input receiving means for receiving an operation input for changing a playback speed, the operation input being received from a user,
wherein in the language-learning playback mode, when an operation input for changing a playback speed is received at the operation input receiving means from the user, the control means changes a speed at which the segmented section is to be repeatedly played back in accordance with the operation input.

6. The playback apparatus according to claim 2, further comprising:
operation input receiving means for receiving an operation input for setting a sub-section in the segmented section, the operation input being received from a user,
wherein in the language-learning playback mode, when an operation input for setting a sub-section in the segmented section is received at the operation input receiving means from the user, the control means repeatedly plays back the sub-section in the segmented section.

7. The playback apparatus according to claim 2,
wherein a start point and end point of the segmented section are superimposed and displayed on the video based on the video information,
wherein the playback apparatus further comprises operation input receiving means for receiving an operation input for moving at least one of the start point and end point of the segmented section, the operation input being received from a user, and
wherein in the language-learning playback mode, when an operation input for moving at least one of the start point and end point of the segmented section is received at the operation input receiving means from the user, the control means corrects a position of the at least one of the start point and end point of the segmented section in accordance with the operation input.

8. The playback apparatus according to claim 2, further comprising:
operation input receiving means for receiving an operation input for instructing detection of a silent period in audio information currently being played back, the operation input being received from a user,
wherein in the language-learning playback mode, when an operation input for instructing detection of a silent period is received at the operation input receiving means from the user, the control means detects a silent period in audio information currently being played back, and corrects at least one of a start point position and end point position of the segmented section in accordance with the detected silent period.

9. The playback apparatus according to claim 7, further comprising:
second operation input receiving means for receiving an operation input for instructing display of a waveform of audio information currently being played back, the operation input being received from the user,
wherein in the language-learning playback mode, when an operation input for instructing display of a waveform is received at the second operation input receiving means from the user, the control means superimposes and displays an audio signal waveform of the segmented section on the video based on the video information in accordance with display of the start point and end point of the segmented section.

10. The playback apparatus according to claim 2, further comprising:
native language storage means for receiving a setting of a native language of a user and storing a native language version in advance;
dictionary means for storing native-language meanings of words of the plurality of languages shown in the subtitles in a manner in which the meanings can be retrieved from the dictionary means, the native-language meanings being given in the native language; and
operation input receiving means for receiving an operation input for instructing dictionary retrieval of a meaning of a word included in a subtitle superimposed and displayed on video currently being played back, the operation input being received from the user,
wherein in the language-learning playback mode, when an operation input for instructing search of a meaning of a word included in a subtitle superimposed and displayed on video currently being played back is received at the operation input receiving means from the user, the control means searches the dictionary means for a meaning of a word in a subtitle displayed in a segmented section currently being played back, and superimposes and displays a found meaning on the video based on the video information.

11. The playback apparatus according to claim 1, further comprising:
means for recognizing a plurality of language versions recorded on the recording medium and notifying a user of a list of languages allowed in the language-learning playback mode; and
selection input receiving means for receiving an input of a target language to be learned by the user, the target language being selected by the user from among the allowed languages,
wherein the control means extracts and plays back, from the recording medium, audio information including utterance information in a language and subtitle information corresponding to the utterance information, the language being the target language received at the selection input receiving means.

12. A playback method in a playback apparatus for playing back video information, audio information, and subtitle information from a recording medium, the recording medium having recorded thereon video information, audio information associated with the video information, and subtitle information corresponding to utterance information included in the audio information, the utterance information and the subtitle information being given in a plurality of languages, the playback method comprising the steps of:
when mode switching means for switching between a normal playback mode and a language-learning playback mode switches the playback apparatus to the language-learning playback mode, playing back video information and audio information associated with the video information and reading, from the recording medium, subtitle information given in the same language as a language of utterance information included in the audio information to be played back to perform playback in which subtitles based on the subtitle information are superimposed and displayed on video based on the video information.

13. The playback method according to claim 12, wherein the recording medium has recorded thereon information regarding a start point and an end point of a superimposition time period for which a subtitle based on the subtitle information is superimposed on the video based on the video information,
the playback method further comprising the steps of:
reading the start point and the end point of the superimposition time period from the recording medium and detecting the read start point and end point as a start point and an end point of a language-learning segmented section; and
performing control in the language-learning playback mode to repeatedly play back the detected segmented section, the segmented section being a section in which the subtitle information is superimposed on the video based on the video information.

14. A playback apparatus for playing back video information, audio information, and subtitle information from a recording medium, the recording medium having recorded thereon video information, audio information associated with the video information, and subtitle information corresponding to utterance information included in the audio information, the utterance information and the subtitle information being given in a plurality of languages, the playback apparatus comprising:
a mode switching unit configured to switch between a normal playback mode and a language-learning playback mode; and
a control unit configured to, when the language-learning playback mode is set by the mode switching unit, play back video information and audio information associated with the video information and read, from the recording medium, subtitle information given in the same language as a language of utterance information included in the audio information to be played back to perform playback in which subtitles based on the subtitle information are superimposed and displayed on video based on the video information.
